(19) United States
(12) Patent Application Publication
(10) Pub. No.: US 2009/0173122 A1
(43) Pub. Date: Jul. 9, 2009

(54) Soluble Fertilizer for Organic Agriculture From Distiller's Yeast

(76) Inventor: Timothy Allan Stemwedel, Fresno, CA (US)

Correspondence Address: Timothy Allan Stemwedel, Suite 121, 7600 N. Ingram Ave., Fresno, CA, 93711, US

(21) Appl. No.: 11/969,755

(22) Filed: Jan. 4, 2008

(51) Int. Cl. C05F 11/00

(52) U.S. Cl. 71/11

(57) ABSTRACT

The invention is a soluble, liquid or dry fertilizer for application to a plant or soil that is grown or farmed as “organic” as defined under the USDA National Organic Program Rule. The fertilizer is produced from distiller's yeast from beer and/or alcohol production. The yeast cells are autolyzed using heat and the autolysates are separated by centrifugation into insoluble cell walls and cellular plasma. The plasma is concentrated by evaporation into the fertilizer. The fertilizer may be further processed by proteolytic enzyme (protease) hydrolysis to produce smaller-sized, soluble, Nitrogen-containing compounds including protein, peptides, amino acids, amines and ammonia. The fertilizer has a solids content between ten and sixty-five percent, a total protein content of at least ten percent and up to eighty-five percent, a total Nitrogen content between one and fourteen percent, and a pH between 2.5 and 10.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The fertilizer of this invention reduces demand for fossil-fuel-produced fertilizer. Brewer's yeast waste from breweries is used as an animal feed substance. Since organic agriculture is required to utilize natural sources of Nitrogen for fertilization, yeast is a good source of Nitrogen-containing protein.

1. Field of Invention

This invention relates, in general, to fertilizers for providing nutrients to plants, and, in particular, applies to fertilizers for “organic production” as defined in the Code of Federal Regulations Title 7, Part 205, Section 205.2.

2. Description of Related Art

Organic production does not allow for the use of chemically processed or derived fertilizers commonly used in conventional agriculture. Some examples of these fertilizers are Urea, Ammonia, Ammonium Nitrate, Phosphoric Acid, Ammonium Phosphate compounds, and Calcium Nitrate. Materials that are allowed in organic production must be natural, organic materials or raw, mined minerals with few exceptions.

Currently, organic farms use the following materials for fertilization of the crops:
Compost derived from animal waste or other materials allowed by the National Organic Program Rule,
Fresh plant material from incorporating a Nitrogen-fixing crop into the soil,
Raw animal manures (not sewage sludge),
Animal or plant materials which include fish meal, blood meal, feather meal, soybean meal, and other high protein containing materials.

Plant or animal protein materials are commonly used in organic production since protein is a Nitrogen-containing compound. In general, every kilogram of protein contains approximately 160 grams of Nitrogen. Protein Nitrogen when applied to the soil requires biological decomposition into a form useable by plants. Protein by-products from rendered animals contain between 50 and 85 percent protein, as well as other essential elements required by plants such as Phosphorus, Calcium, Potassium and Iron. These protein products are used in powder or pellet form, as offered by California Organic Fertilizers, Inc. These fertilizer products contain between 4% and 12% Nitrogen. California Organic Fertilizers, Inc. has been successful in marketing these products for organic production for 17 years.

There are many benefits to using natural organic materials as a source of fertilizers. These products are generally by-products of other agricultural industries. They are low in salts, so they do not pose a hazard relative to irrigation or rainfall run-off. The low salt level also aids in improving the quality of the soil. The low nitrate formation of these products also produces food with lower nitrates. They are not manufactured using fossil fuel. These products are not soluble salts so they do not leach easily into ground water aquifers.

Prior Art

Prior fertilizer development efforts failed to appreciate the value of yeast lysate and hydrolysates as a fertilizer for organic production. In addition, prior development efforts failed to consider the further processing of these materials using enzyme hydrolysis to produce water-soluble Nitrogen-containing fertilizers.

U.S. Pat. No. 7,074,251

Filing date: Jul. 21, 2000

Issue date: Jun. 11, 2006

Inventors: Peter John Rogers, Robert White Gilbert, Michael Andrew Pecar

This invention fails to discover the use of heat to rupture the yeast cells for extraction of the cell plasma for use as a more concentrated fertilizer. This invention fails to discover the use of enzymes to further reduce the molecule size of the yeast cell plasma from proteins into peptides, amino acids and ammonia. Rogers, et al, also did not invent the autolysis of the yeast cells and subsequent separation of the cell walls from the distiller's yeast, thereby creating a fully soluble fertilizer of hydrolyzed yeast autolysates.

U.S. Pat. No. 4,218,481

Filing date: Oct. 6, 1978

Issue date: Aug. 19, 1980

Inventors: Chao et al.

Chao and his associates revealed that yeast autolysis is enhanced by the addition of certain exogenous enzymes to the yeast slurry. The enzyme used may be papain, ficin, bromelain, and aspergillus protease. The purpose of the process is to produce a soluble protein product for use as a palatable food. Chao failed to discoverr the potential of using the yeast protein hydrolysate as an organic fertilizer.

U.S. Pat. No. 4,264,628

Filing date: Aug. 7, 1979

Issue date: Apr. 28, 1981

Inventors: Frank F. Hill

Hill reveals a process to recover a liquid yeast lysate by using fatty acids to accelerate and enhance the autolysis process. Hill did not utilize added enzymes or discover the potential of using the yeast protein hydrolysate as an organic fertilizer.

### BRIEF SUMMARY OF THE INVENTION

The invention is a soluble liquid or dry fertilizer for application to a plant or soil that is grown or farmed as “organic” as defined under the USDA National Organic Program Rule. The fertilizer is produced from brewer's yeast, which is a by-product of the beer and alcohol industry. The fertilizer is produced by protolytic enzyme (protease) hydrolysis to reduce proteins to small-size, water-soluble, Nitrogen-containing compounds including protein, peptides, amino acids, amines and ammonia. The fertilizer has a solids content between five and ninety-five percent, a total Nitrogen content between one and thirteen percent, and a pH between 2.5 and 10.

### BRIEF DESCRIPTION OF THE SEVERAL VIEWS OF THE DRAWING

Not Applicable

### DETAILED DESCRIPTION OF THE INVENTION

Distiller's yeast is a co-product of beer and alcohol production.

The liquid distiller's yeast is heated to between 131 and 180 degrees Fahrenheit to cause autolysis of the yeast cells. The percentage of the autolysis of the liquid distiller's yeast may be improved by using a caustic material to increase the pH.

The resulting mixture is processed by proteolytic enzyme (protease) hydrolysis to produce smaller-sized, water-soluble, Nitrogen-containing compounds including protein, peptides, amino acids, amines, and ammonia. This is achieved by mixing the autolyzed distiller's yeast and enzymes and allowing the enzymes to hydrolyze the proteins in the mixture.

The proteins in claim 1 are hydrolyzed using proteolytic enzymes (proteases) such as papain, bromelain, or other protease enzymes, separate or in combination, at a rate which will hydrolyze between 25 percent and 90 percent of the proteins. (e.g., Papain, at 85 T.U./mg, may be used at a rate of 0.01% and 0.05% to accomplish this degree of hydrolyzation.)

The insoluble, solid yeast cell walls are removed and the water/yeast mix is then concentrated. Removal of the insoluble solids may be done using filters or centrifuges. Concentration may be achieved by using equipment such as evaporators, spray dryers, or membrane filters.

The resulting fertilizer has the following characteristics:
a. The fertilizer has a solids content between 10 to 65 percent solids on a weight to weight basis;
b. The fertilizer has a total Nitrogen content between 1.0 and 14 percent on a weight to weight basis;
c. The fertilizer has a final pH of between 2.5 and 10;
d. The fertilizer may be dried into a soluble solid;
e. The fertilizer is stable at normal environmental temperatures and requires no special handling.

Following, is a characteristic example of the nutrient content on an “as-is” basis for fertilizer produced using this invention:

| | |
|---|---|
| Total Nitrogen | 6.00% w/w |
| Water Soluble Nitrogen | 5.95% w/w |
| Phosphorus | 0.25% w/w |
| Potassium | 0.25% w/w |
| Calcium | 0.50% w/w |

1. A Nitrogen-containing liquid fertilizer for application to a plant or soil which is grown or farmed as “organic” as defined under the USDA National Organic Program Rule comprising:
a. Autolyzed distiller's yeast from beer and/or alcohol production;
b. Wherein the distiller's yeast is heat treated to cause autolysis of the yeast cells;
c. Wherein the insoluble cell walls of the yeast are separated from the soluble yeast autolysates using centrifugation;
d. Wherein the soluble autolysates are concentrated by evaporation;
e. Wherein the distiller's yeast has a solids content between 10 to 65 percent solids on a weight to weight basis;
f. Wherein the distiller's yeast has a total protein content of 10 to 75 percent on a weight to weight basis;
g. Wherein the distiller's yeast has a water content between 40 and 90 percent on a weight to weight basis.

2. The liquid fertilizer described in claim one, which additionally is processed by enzyme hydrolysis:
a. Wherein the remaining protein in the autolysates is further degraded into smaller-sized soluble molecules including polypeptides, amino acids, amines and ammonia;
b. Wherein the proteins are hydrolyzed using proteolytic enzymes (proteases) such as papain, bromelain or other protease enzymes.

3. The liquid fertilizer described in claim two, which additionally has the following characteristics:
a. Wherein the liquid fertilizer has a solids content between 10 to 65 percent solids on a weight to weight basis;
b. Wherein the liquid fertilizer has a total protein content of 10 to 85 percent on a weight to weight basis;
c. Wherein the liquid fertilizer has a water content between 40 and 90 percent on a weight to weight basis;
d. Wherein the liquid fertilizer has a Nitrogen content between 1 and 14 percent on a weight to weight basis;
e. Wherein the liquid fertilizer has a final pH of between 2.5 and 10;
f. Wherein the liquid fertilizer may be dried into a soluble solid.
